(19) United States
(12) Patent Application Publication
(10) Pub. No.: US 2013/0075590 A1
(43) Pub. Date: Mar. 28, 2013

(54) IMAGE SENSORS HAVING MULTIPLE ROW-SPECIFIC INTEGRATION TIMES

(71) Applicant: John T. Compton, LeRoy, NY (US)

(72) Inventor: John T. Compton, LeRoy, NY (US)

(73) Assignee: TRUESENSE IMAGING, INC., Rochester, NY (US)

(21) Appl. No.: 13/627,052

(22) Filed: Sep. 26, 2012

Related U.S. Application Data
(60) Provisional application No. 61/540,107, filed on Sep. 28, 2011.

(51) Int. Cl. H01L 27/146

(52) U.S. Cl. 250/208.1

(57) ABSTRACT

In various embodiments, reset is suppressed for at least one selected row of pixels in a pixel array during a rolling shutter operation, thereby setting the integration time of the selected row(s) to the full-frame integration time.

### RELATED APPLICATION

This application claims the benefit of and priority to U.S. Provisional Patent Application No. 61/540,107, filed Sep. 28, 2011, the entire disclosure of which is hereby incorporated herein by reference.

### TECHNICAL FIELD

The present invention relates, in various embodiments, to control of pixel integration time in image sensors.

### BACKGROUND

The integration time for pixels in a complementary metal-oxide-semiconductor (CMOS) image sensor is typically controlled by resetting the pixels in a line-sequential (i.e., line-by-line) fashion and reading out the pixels in a line-sequential fashion, where the “integration time” of a line of pixels is the delay between the resetting of a given line and the reading of that line. Such a line-sequential reset and read-out operation is commonly termed “rolling shutter” or “electronic focal plane shutter” operation, as it operates analogously to a focal-plane shutter utilized in a single-lens reflex (SLR) film or digital camera. In FIG. 1, an array 100 is composed of rows and columns of CMOS pixels 102. When capturing an image, the pixels of the array 100 are typically reset row-by-row starting from the top of the array and continuing downward. After each row is reset, each pixel in the row begins to collect light-induced charge (or “photocharge”) at a rate dependent on the incident light intensity on the pixel. The row-reset process is indicated by a reset pointer 104, which is a graphical depiction of the row currently selected for reset. The row-reset process is followed some time later by a row-readout process, in which the pixels of the array 100 are typically read row-by-row starting from the top of the array and continuing downward. The row-readout process is indicated by a read pointer 106, which is a graphical depiction of the row currently selected for readout. The process of reading out a row of pixels typically takes more time than the process of resetting a row of pixels. In order to ensure that the amount of time between a particular row being reset and the same row being read out is consistent along the entire array 100, the row-reset process typically proceeds at exactly the same rate as the row-readout process. The row-readout process measures the amount of photocharge that has accumulated in each pixel of the row between the time the row was reset by the row-reset process and the time the pixel is read in the row-readout process. The time between reset and readout is the exposure time or integration time for the image being captured, as mentioned above. The integration time is indicated on FIG. 1 by the double-headed arrow 108 between the reset pointer 104 and the read point 106.

FIG. 2 illustrates a conventional arrangement of CMOS pixels (like pixel 102 above) commonly known as a four-transistor four-shared (4T4S) arrangement of CMOS pixels. In FIG. 2 there are four independent photodiodes 202A, 202B, 202C, and 202D that are adapted to collect photocharge. These photodiodes are respectively connected to adjacent floating diffusions 206A, 206B, 206C, and 206D by transfer gates 204A, 204B, 204C, and 204D. The transfer gates permit the transfer of collected photocharge from the photodiode into the floating diffusion. In the arrangement shown in FIG. 2, the photodiodes and associated structures are arranged in two rows with two pixels per row. This two-by-two arrangement is tiled vertically and horizontally to produce the rows and columns of an array of pixels. The transfer gates are operated in common for two rows of pixels by respective transfer gate control lines 208A, 208B, 208C, and 208D. The four floating diffusions are connected together by a conductor 210 that also connects the floating diffusions to a source follower transistor 212. The source follower transistor 212 drives a column output line 218 through a row select transistor 214. The column output line 218 is shared by all the source follower outputs in two columns of pixels. Row select transistor 214 isolates the source follower from the column output line until the pixels in the row associated with the row select transistor are to be read out. When the pixels in a row are to be read out, the row select transistors 214 for the row are operated in common by a row select control line 216. The four floating diffusions are also connected by conductor 210 to a reset gate 220, which permits the floating diffusions to be reset to a known state prior to charge being transferred into them from their respective photodiodes. The reset gates 220 for a row are operated in common by a reset gate control line 222.

When a row of pixels is selected for reset by the reset pointer, reset gate control line 222 is used to momentarily turn on reset gate 220 to remove charge from floating diffusions 206A-206D. Afterward, one or more of the transfer gates 204A-204D are momentarily turned on by their respective transfer gate control lines 208A-208D. This removes charge from the affected photodiode(s). When the transfer gate(s) turn off, the photodiodes immediately begin collecting photocharge.

When a row of pixels is selected for readout by the readout pointer, row select transistor 214 is turned on by common row select control line 216 to connect source follower transistor 212 to common column output line 218. As with the row-reset process, reset gate control line 222 is used to momentarily turn on reset gate 220 to remove charge from floating diffusions 206A-206D. After the reset gate 220 is turned off, the floating diffusion voltage is sampled by circuitry that is external to the pixel array that is connected to the common column output line 218. Then, one or more of the transfer gates 204A-204D are momentarily turned on by their respective transfer gate control lines 208A-208D in order to transfer collected photocharge from the affected photodiode(s) into the floating diffusions for measurement and sampling by circuitry external to the pixel array that is connected to the common column output line 218. The difference between the reset sample and the charge transfer sample provides the measured result (i.e., the measured intensity level) for the pixel.

From the foregoing descriptions of the reset and readout processes for a CMOS pixel, it is seen that collected charge is removed from the photodiode in both cases. For the longest exposure time, it is possible to eliminate the reset process entirely and simply use the reset of the photodiodes due to the readout process as the beginning of the exposure time for the next readout. In this case, the exposure time for each pixel is the same as the time required to read out all the pixels of the array one row at a time. This exposure time may be suitable for capturing an image of a very dark scene, but for brightly illuminated scenes this long exposure time may cause some photodiodes to become over-filled with photocharge. The reset process described earlier is useful for controlling the exposure time to avoid this problem.

Since there are four photodiodes in FIG. 2, it is possible to reset them at four different times but read them out at the same time in order to have four different exposure times. However, such a scheme generally requires additional reset pointers and added time in each row to go through the additional reset sequences. The additional reset pointers add significantly to the control circuitry for the image sensor, and the added time for reset may increase the overhead time for each row. Thus, there is a need for techniques to vary the integration time of a CMOS image sensor in a row-by-row fashion without the added complexity of additional reset pointers and the time consumption their use entails.

### SUMMARY

Embodiments of the present invention have at least two different exposure times applied to different photodiodes (e.g., different rows of pixels) without the shortcomings set forth above by suppressing the operation of one or more of the transfer gate control lines during the reset process. By doing so, the corresponding photodiodes are not reset and continue to accumulate photocharge. In this manner, the reset associated with readout for those photodiodes serves as the reset to begin the exposure for the photodiodes for their next readout. By this approach, some photodiodes are reset normally by the reset to have a selected, shorter exposure time, and some photodiodes have the reset pointer's reset process suppressed, or masked, so that the exposure time for the latter photodiodes extends from one read of the pixel to the next. In various embodiments of the invention, image sensors utilize very little additional circuitry to enable the pixel-reset suppression, e.g., a control register to hold bits, one for each set of transfer gate control lines to be affected, and a corresponding logic function in each transfer gate control line to enable or disable the transfer gate operation during the reset process. In the case of the 4T4S arrangement shown in FIG. 2, the control register holds four bits, one for each of the four transfer gate control lines.

When some pixels have a long exposure time while the remaining pixels have a shorter exposure time, the captured image reflects two different exposure times. The pixels having a long exposure time may be useful for picking up shadow detail, while the pixels having a shorter exposure time may be useful for avoiding washout (i.e., properly exposing bright areas of a scene). The combination of the two sets of pixels may thus increase the dynamic range of the resulting image.

In an aspect, embodiments of the invention feature an image sensor including or consisting essentially of a pixel array comprising a plurality of rows of pixels for accumulating charge in response to incident light, a row-driver circuit associated with each row of pixels, and a control circuit electrically connected to the row-driver circuits. The control circuit is configured to (i) for each row of pixels, reset the row of pixels by applying a row-reset signal to the row-driver circuit associated therewith and, thereafter, read out charge from the row of pixels, and (ii) for at least one selected row, suppress reset of at least one pixel (even all pixels) thereof to allow charge to accumulate therein for a full-frame integration time prior to read-out. Unselected rows have an integration time (a) less than the full-frame integration time and (b) corresponding to an elapsed time between application of the row-reset signal and read-out.

Embodiments of the invention may include one or more of the following in any of a variety of combinations. The control circuit may include or consist essentially of (i) a row-reset control line for carrying the row-reset signal and (ii) a reset-enable control line for carrying a reset-enable signal for enabling and suppressing reset. Each row-driver circuit may include or consist essentially of circuitry (i) having inputs connected to the row-reset control line and the reset-enable control line and (ii) for performing a logical conjunction of the row-reset signal and the reset-enable signal. The control circuit may include a reset-row-address control line for carrying a reset-row-address signal for addressing a row to be reset. The circuitry may have an input connected to the reset-row-address control line. The circuitry may include or consist essentially of one or more AND gates (or, equivalently, one or more NAND gates).

In another aspect, embodiments of the invention feature a method of image capture utilizing a pixel array including or consisting essentially of (i) a plurality of rows of pixels for accumulating charge in response to incident light and (ii) a row-driver circuit associated with each row of pixels. The pixel array is exposed to incident light. For each row of pixels, the row of pixels is reset by applying a row-reset signal to the row-driver circuit associated therewith, and, thereafter, charge is read out from the row of pixels. For at least one selected row, reset of at least one pixel of the selected row is suppressed to allow charge to accumulate therein for a full-frame integration time prior to read-out. Unselected rows have an integration time (a) less than the full-frame integration time and (b) corresponding to an elapsed time between application of the row-reset signal and read-out. Suppressing reset of at least one pixel of a selected row of pixels may include or consist essentially of applying to the at least one pixel of the selected row a reset-enable signal having a polarity opposite a polarity of the row-reset signal applied to the selected row.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and may exist in various combinations and permutations. As used herein, the terms “approximately” and “substantially” mean±10%, and in some embodiments, ±5%. The term “consists essentially of” means excluding other materials that contribute to function, unless otherwise defined herein. Nonetheless, such other materials may be present, collectively or individually, in trace amounts.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a simplified plan view of a conventional CMOS image sensor;

FIG. 2 is a circuit diagram of a set of four conventional CMOS image-sensor pixels;

FIG. 3 is a block diagram of an image sensor in accordance with various embodiments of the invention;

FIG. 4 is a simplified schematic of portions of an image sensor in accordance with various embodiments of the invention;

FIG. 5 is a schematic diagram of a pixel of an image sensor in accordance with various embodiments of the invention;

FIGS. 6A-6J are schematic diagrams illustrating the progression and suppression of reset and read-out processes applied to an image sensor in accordance with various embodiments of the invention; and

FIG. 7 is a timing diagram corresponding to the sequence depicted in FIGS. 6A-6J.

### DETAILED DESCRIPTION

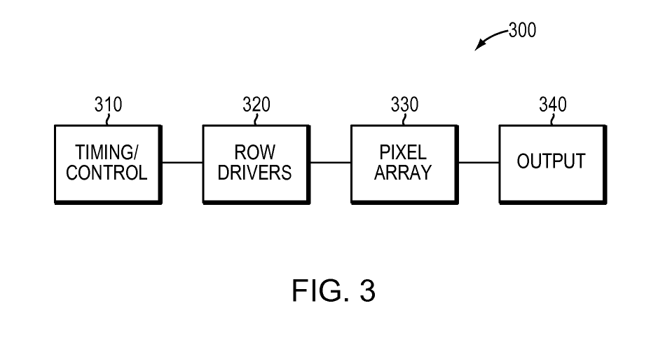

As mentioned above, embodiments of the present invention mask, or prevent the operation of, the reset process for selected pixels while permitting the reset operation to take place for non-selected pixels. The selected pixels then integrate from read operation to read operation, for full-frame integration time (i.e., the amount of time between successive read operations performed on the same row), while the non-selected pixels have normally controlled partial frame integration time (i.e., the typical selected integration time for the pixels in the image sensor, which is normally less than the full-frame integration time). Various embodiments of the invention enable the row-reset suppression utilizing, e.g., additional instructions in the timing-control block (e.g., in digital circuits) or small modifications to existing row-driver circuits (e.g., in analog circuits). As utilized herein, a “row” of pixels in an image sensor is not necessarily oriented horizontally; rather, rows of pixels may be linear groups of pixels that are preferably oriented parallel to each other with an arbitrary (e.g., horizontal, vertical, etc.) orientation. Moreover, a row of pixels may be a group of pixels that are not necessarily consecutively arranged linearly or areally, but instead are merely reset and/or read-out in common. (As shown in FIG. 2, a line of pixels may include multiple groups of pixels that may each have a different timing; thus, a “row,” as utilized herein, may refer to only one such group of pixels, e.g., every other pixel in a line of pixels.)

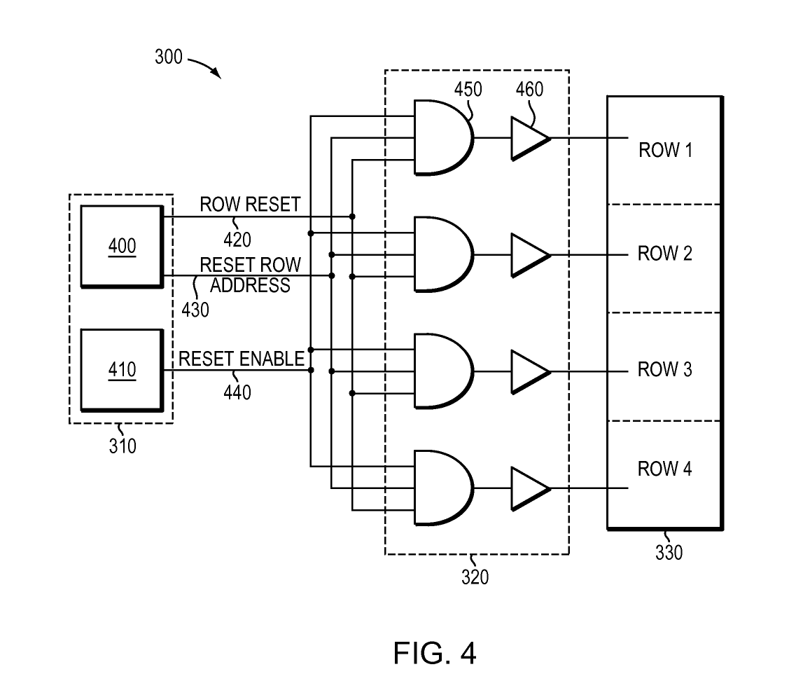

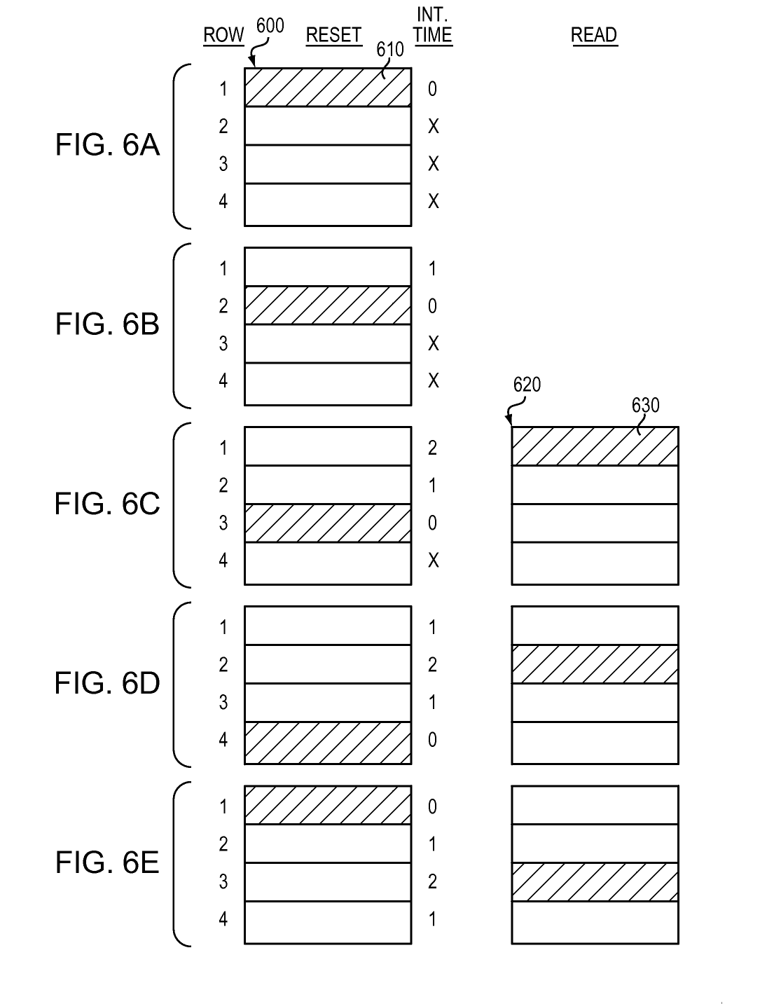

FIG. 3 is a simplified block diagram of an image sensor 300 in accordance with various embodiments of the present invention. As shown, image sensor 300 includes timing and control circuits 310, a set of row-driver circuits 320, a pixel array 330 (similar to array 100) that contains multiple rows of photosensitive pixels (e.g., a pixel depicted in FIG. 2 or 5), and a set of output circuits 340. The timing and control circuits (or “controller” or “control system”) 300 controls various operations of the image sensor 300 (and the pixel array 330), including the row-by-row reset function described herein that empties any remnant charge from a row of pixels (and is typically performed at the beginning of a desired integration time). The controller 310 may be a general-purpose microprocessor, but depending on implementation may alternatively be a microcontroller, peripheral integrated circuit element, a customer-specific integrated circuit (CSIC), an application-specific integrated circuit (ASIC), a logic circuit, a digital signal processor, a programmable logic device such as a field-programmable gate array (FPGA), a programmable logic device (PLD), a programmable logic array (PLA), an RFID processor, smart chip, or any other device or arrangement of devices that is capable of implementing various steps of the processes of the invention (such as those described in detail below). The controller 310 may be monolithically integrated with, and thus a portion of the same integrated-circuit chip as, pixel array 330 and row drivers 320, or controller 310 may be disposed on a chip separate and discrete from the chip containing pixel array 330 and row drivers 320 (and interconnected thereto by wired or wireless means). Moreover, at least some of the functions of controller 310 may be implemented in software and/or as mixed hardware-software modules. Software programs implementing the functionality herein described may be written in any of a number of high level languages such as FORTRAN, PASCAL, JAVA, C, C++, C#, BASIC, various scripting languages, and/or HTML. Additionally, the software may be implemented in an assembly language directed to a microprocessor resident in controller 310. The software may be embodied on an article of manufacture including, but not limited to, a floppy disk, a jump drive, a hard disk, an optical disk, a magnetic tape, a PROM, an EPROM, EEPROM, field-programmable gate array, CDROM, or DVDROM. Embodiments using hardware-software modules may be implemented using, for example, one or more FPGA, CPLD, or ASIC processors.

The row drivers 320 drive the individual rows of the pixel array 330 based on signals received from the timing and control circuits 310 and an embodiment of the row drivers 320 is described in more detail below. The output circuit 340 receives pixel output (e.g., intensity information) from the pixel array 330 and sends it out of image sensor 300 (or to another region of image sensor 300 having additional integrated electronics) for further processing and/or storage. The pixel output may be sent to the output circuit 340 in row-by-row fashion, pixel-by-pixel fashion, or in batches corresponding to multiple pixels (e.g., one to four pixels). The output circuit 340 may include or consist essentially of digital and/or analog circuitry, and may include, e.g., sample-and-hold circuitry, analog-to-digital converters, analog and/or digital gain circuits, and/or digital image processing functionality (e.g., offset and/or gain correction). The various blocks 310, 320, 330, 340 depicted in FIG. 3 may each be physically resident on a single die (i.e., a semiconductor chip), or they may all be integrated on one or more dies.

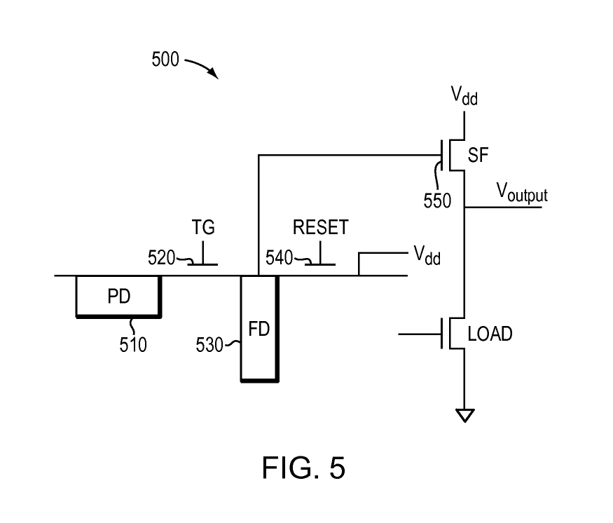

FIG. 4 is a more detailed schematic of various portions of the image sensor 300. As shown, timing and control circuits 310 may include or consist essentially of timing control blocks 400, 410 (while control blocks 400, 410 are depicted as separate for clarity in FIG. 4, in various embodiments control blocks 400, 410 are portions of a single control block and/or circuit). In various embodiments of the invention, control block 400 provides a row reset control signal 420 and a reset row address control signal 430. The control signals 420, 430 combine together to identify a desired row in pixel array 330 for reset, thereby discarding any remnant photocharge in pixels of the row and restarting the integration time for those pixels. Also in various embodiments, control block 410 provides a reset enable control signal 440 that is utilized to selectively suppress the reset signal (i.e., that is otherwise defined for a particular row by signals 420, 430) in desired rows.

The control signals 420, 430, 440 control the operation of row drivers 320, which provide operation signals to the various rows of pixels in array 330, as shown. In various embodiments, the row driver circuits 320 include multiple AND gates 450, each of which controls operation of a single row of array 330. As shown, each AND gate 450 performs a logical conjunction on control signals 420, 430, 440, and thus resetting the pixel row corresponding to the particular AND gate 450 requires not only that the row reset signal 420 and the reset row address signal 430 be high (i.e., a binary “1”), but also that the row enable signal 440 is high. Thus, as described in more detail below, the suppression of the resetting of particular rows may be accomplished without disrupting the timing and control signals of control block 400, but rather by the addition of control block 410 (and its control signal 440). In typical embodiments, rows of array 330 are reset in a predefined, regular pattern (i.e., at a predetermined rate, row-by-row, down the entire array), and the timing of the regular reset signal is not disrupted in order to suppress reset of various rows. Rather, the rows where reset suppression is desired are merely identified and controlled via use of control signal 440. Also as shown, the output of each AND gate 450 may be directed to a buffer/driver circuit 460 that provides the desired control (e.g., reset) signal to the rows in array 330.

One of ordinary skill in the art will recognize that the three-input AND gate 450 may also be implemented as a multiple two-input AND gates (or NAND gates) or otherwise incorporated into other driver or control sub-circuits in such a way as to minimize the overall impact on the design. (For example, the reset-enable signal 440 may be incorporated into a virtual AND gate in the buffer/driver circuits 460.)

FIG. 5 illustrates a pixel 500 in accordance with various embodiments of the present invention. As shown, the pixel 500 includes or consists essentially of a photodiode 510, a transfer gate 520, a sense node (or, equivalently, a “floating diffusion,” “memory node,” or “conversion node”) 530, a reset gate 540, and a source follower 550. The photodiode 510 accumulates photocharge in response to incident light (e.g., from a scene to be imaged by the image sensor). The transfer gate 520 controls the flow of such charge from the photodiode 510 into the sense node 530 for conversion into voltage. The reset gate 540 is utilized to “reset” the sense node by discarding the charge therewithin; activation of the reset gate 540 moves the charge from the sense node 530 into the power supply node (V_{dd}). The source follower 550 (which may include or consist essentially of a transistor, as shown, or may include or consist essentially of another type of buffer) outputs a voltage that is proportional to the amount of charge on the sense node 530. Thus, when a pixel (or its photodiode) is “reset,” as utilized herein, both the transfer gate 520 and the reset gate 540 operate to remove photocharge from the photodiode 510 and discard it, via the sense node 530, into the power supply node. The reset starts the integration time for the pixel (as charge once again begins to accumulate within the photodiode in response to incident light) that ends upon a read operation. During a typical read operation, the reset gate is activated to discard any charge from the sense node 530, and the output of the source follower 550 is read to establish a “reset level” (or “zero level”) of charge. Thereafter, the transfer gate 520 is utilized to move charge from the photodiode 510 into the sense node 530, and the output of the source follower 550 is read to establish a “signal level” of charge. (Thus, as described herein, a read operation also “resets” the photodiode 510 by removing charge therefrom, effectively also restarting an integration time for a subsequent read operation in the absence of a reset operation therebetween.) The difference between the signal level and the reset level represents the measure of charge within the photodiode 510.

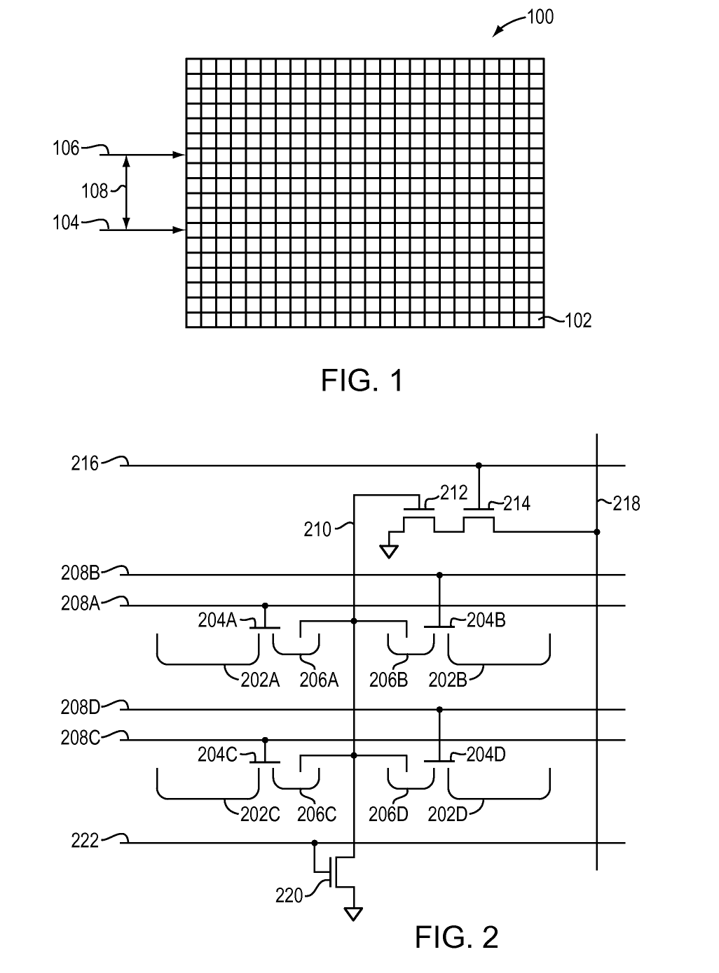

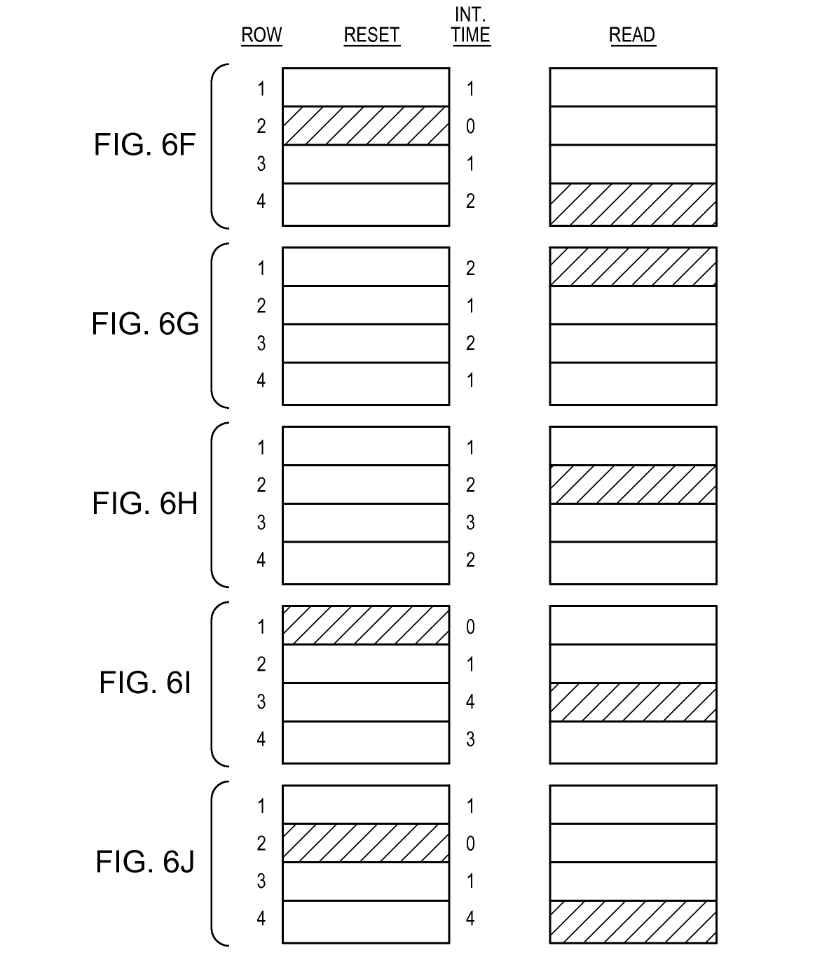

FIGS. 6A-6J illustrate the operation of an image sensor during a rolling shutter operation similar to that described with reference to FIG. 1. Generally, each of FIGS. 6A-6J depicts a first simplified schematic 600 of the pixel array of the image sensor that indicates the row-by-row position of a reset pointer 610 (indicated by the shading in the row being reset), as well as the resulting row-by-row integration time. As described above, when a row of the pixel array is reset, the integration time resets to zero and photocharge can once again begin to accumulate within that row thereafter. For FIGS. 6A-6J, an integration time indicated by “X” is unknown. For example, at initial start-up or after a period of disuse, the amount of charge within a row of pixels, as well as the amount of time over which the charge has built up, may be unknown and necessitate a reset operation to be set at a known value (here, a zero level).

Most of the FIGS. 6A-6J also depict a second simplified schematic 620 of the pixel array that indicates the row-by-row position of a read pointer 630 (indicated by the shading in the row being read). As discussed above, after the read operation, the integration time of the read row also resets back to zero. FIGS. 6A and 6B lack a schematic 620 because, in the illustrated embodiment, the pixel array is not prepared for a read operation. In the illustrated embodiment, the desired integration time (at least for rows 1 and 2) is two (units are in terms of the number of cycles of the reset and read pointers moving from one row to the next), and thus no read operations may take place until row 1 is reset, two cycles pass, and row 1 is read out in FIG. 6C (when, as indicated, the row 1 integration time has reached two).

As described above, embodiments of the present invention improve the dynamic range of an image sensor on a row-by-row basis by suppressing the reset of particular rows of pixels, thereby increasing the integration time for those pixels relative to the remaining rows. Typically a particular integration time may be defined for all of the rows of pixels (e.g., in the units of FIGS. 6A-6J, two cycles) but the reset operation will be suppressed for one or more of the rows. As a result, those rows of pixels continue to integrate charge from the point at which they were last read (because, as described above, a read operation resets the pixels) until the read pointer cycles through the entire array and reaches the desired rows again. That is, since the reset pointer effectively skips the rows in which the reset operation is suppressed, the integration time for such rows (again, in the units of FIGS. 6A-6J) is equal to the number of rows in the entire array, i.e., the integration time is the “full-frame” integration time.

A more detailed analysis of FIGS. 6A-6J further elaborates on the embodiments of the invention described above. As mentioned, at the beginning of the illustrated embodiment, the image sensor has just been powered on or is being utilized after a period of disuse, and the amount of charge in the pixels and the integration times are unknown. Moreover, in the illustrated embodiment, it is desired that rows 1 and 2 be read after an integration time of two but that the reset operation be suppressed for rows 3 and 4, providing these rows with the full-frame integration time (which is 4 in the illustrated embodiment). Since in the illustrated embodiment the image sensor is being utilized immediately after being powered on or after a period of disuse, in an embodiment all of the rows are first reset and read in order to restart the integration times for all rows. Thus, an entire frame of the image being captured is taken but not utilized (instead this image is discarded); the first frame merely prepares all rows for subsequent image capture with the desired row-specific integration times. This start-up sequence is illustrated in FIGS. 6A-6F. As shown in these figures, the reset pointer 610 proceeds through all of rows 1-4, resetting all of the rows and removing uncertainty regarding the integration times of the rows. Since the read pointer 630 follows the reset pointer 610 two rows behind, the initial image is captured, row-by-row, in FIGS. 6C-6F. As detailed above, this image is discarded because it does not contain all of the desired row-wise integration times (all rows had the “standard” integration time of two, while it is desired for rows 3 and 4 to have the full-frame integration time (which is four in the illustrated embodiment)).

FIGS. 6G-6J depict the reset and read process for the rows of pixels in the array that occurs after the initial start-up sequence and discarding of the first image. The sequence of FIGS. 6G-6J may repeat (e.g., for continuous capture of video) as many times as desired. After the events of FIGS. 6A-6F, all rows have just been read, and the reset pointer 610 has wrapped around to the top of the array and reset rows 1 and 2 in the previous two figures. Thus, in FIG. 6G, the integration time for row 1 is two, row 1 having been reset in FIG. 6E, and the integration time for row 2 is one, row 2 having been reset in FIG. 6F. Also in FIG. 6G, the integration time for row 3 is two, row 3 having been read (and thus also reset) in FIG. 6E, and the integration time for row 4 is one, row 4 having been read in FIG. 6F. If the standard sequence (i.e., without reset suppression) were to proceed in FIG. 6G, the reset pointer 610 would be in row 3, thereby resetting row 3. However, since it is desired that row 3 have the full-frame integration time, the reset pointer 610 is suppressed (e.g., via signal 440 in FIG. 4), reset pointer 610 is absent, and row 3 is not reset. Row 1 is read as normal in FIG. 6G, thereby resetting the integration time of row 1.

FIG. 6H is similar to FIG. 6G but corresponds to the reset operation being suppressed in row 4. In FIG. 6H, the integration time of row 1 is one (row 1 having been read in FIG. 6G), the integration time of row 2 is two (and row 2 is being read as shown by the position of read pointer 630), the integration time of row 3 is three (as the typically “scheduled” reset of this row was suppressed in FIG. 6G), and the integration time of row 4 is two (and row 4 is not reset). In FIG. 6I, the read pointer 630 finally reaches row 3, row 3 having integrated for the full-frame integration time of four due to the reset suppression, and the reset pointer 610 has again wrapped around to row 1, resetting row 1 and setting its integration time back to zero. Similarly, in FIG. 6J, the read pointer 630 finally reaches row 4, row 4 having integrated for the full-frame integration time of four due to the reset suppression, and the reset pointer 610 has proceeded to row 2, resetting its integration time. Thus, in FIGS. 6G-6J, a full frame of the captured image has been read (i.e., pixel information has been read from all rows of pixels of the image sensor) in which the pixel charge from rows 1 and 2 has a partial integration time of two cycles and the pixel charge from rows 3 and 4 has the full-frame integration time of four cycles. As mentioned previously, the sequence depicted in FIGS. 6G-6J may be repeated for as many times as full images of the scene are desired, e.g., as a video-stream capture of a scene.

In the above discussion, the first full image captured in the sequence depicted in FIGS. 6C-6F, was merely discarded. However, information received from the initial image may also be utilized to determine, for the next image, which rows of pixels should experience the reset suppression and thus have the full-frame integration time. For example, the first image, which in the illustrated embodiment is captured with all rows having the same integration time, may reveal that one or more portions of the image to be captured are dark (e.g., shadowed); the dynamic range of the image capture may be increased by selectively increasing the integration time for such rows in accordance with embodiments of the invention described herein. For example, referring to the sequence illustrated in FIGS. 6A-6J, the first image captured during FIGS. 6C-6F may reveal that at least portions of rows 3 and 4 are darker or would otherwise benefit from a longer integration time. On the basis of such information, the timing and control circuits 310 suppress the reset operation for the subsequent captured image (i.e., during FIGS. 6G-6J) via reset enable control signal 440 (i.e., setting signal 440 to “low” or a logical zero) such that the reset signal is not delivered to rows 3 and 4 by their corresponding drivers 460. Then, this second image (i.e., captured in FIGS. 6G-6J) may itself be utilized to determine reset suppression for the next captured image, and so on. Alternatively, after the second image has been captured, another “discardable” image (i.e., corresponding to FIGS. 6C-6F) may be captured, analyzed to determine reset suppression for one or more subsequent images, and discarded (i.e., not transmitted to a monitor or other viewport or not recorded or stored), and then one or more images may be captured using the newly determined settings. In this manner, the dynamic range of the image sensor may be increased on a row-wise basis, where different frames utilize different integration times for different rows. Furthermore, embodiments of the invention do not require complicated dedicated reset circuitry for each row of the array; rather, a single reset timing sequence is utilized and suppressed for particular rows on a frame-by-frame basis.

In other embodiments, the rows of the pixel array having their reset suppressed (and thus having the full-frame integration time) may be predetermined or may correspond to a particular image-capture mode for capturing particular types of images. For example, every other row may have its reset suppressed in a monochrome image-capture mode, every other row pair may have its reset suppressed in a color image-capture mode (for example, if the pixel array incorporates the well-known Bayer color filter), or every set of n rows (n being an integer less than the total number of rows in the array) may have their reset suppressed (for example, if the pixel array incorporates a non-Bayer color filter). Alternatively, a number of the bottommost rows may have their reset suppressed for capturing, e.g., images in which a bright sky is above a darker scene. Rows may even be selected for reset suppression based on known or predicted darker contents of the scene, e.g., areas between bright windows or other illumination patterns, etc.

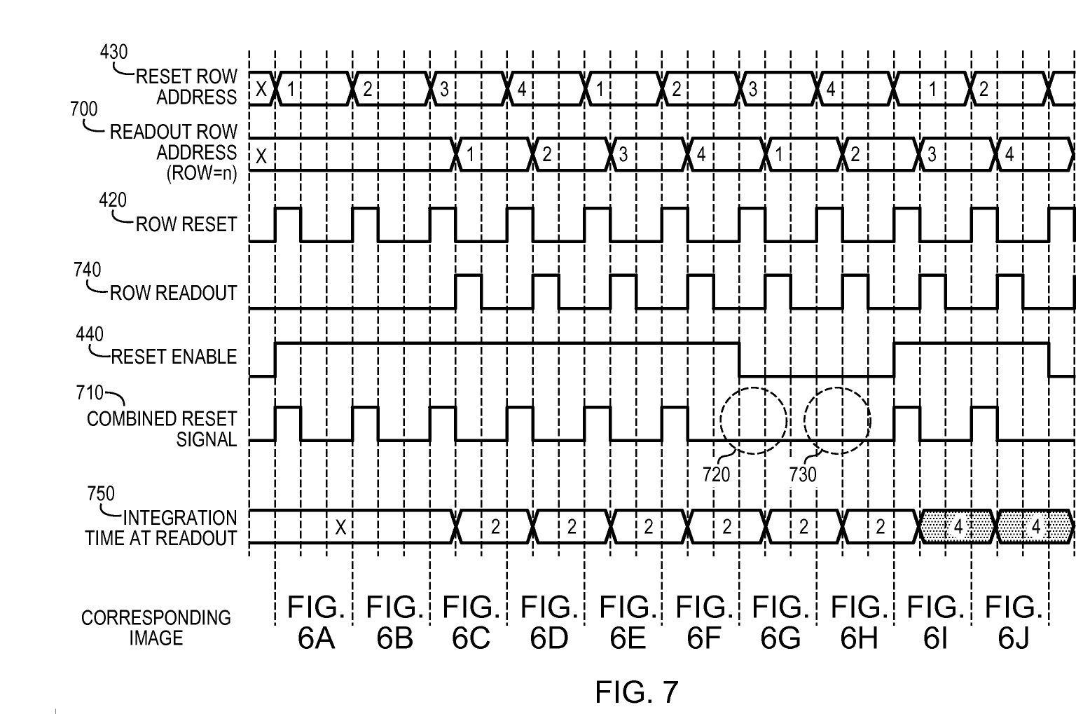

FIG. 7 is a timing diagram depicting the image-capture sequence illustrated in FIGS. 6A-6J. As shown, the reset row address signal 430 cycles through the rows of pixels of the array (i.e., rows 1-4) in sequence, and a readout row address signal 700 cycles through the rows in sequence separated from signal 430 by two rows (as also shown by the two-row separation between reset pointer 610 and readout pointer 620 in FIGS. 6A-6J). The row reset signal 420 is represented as a regularly repeating pulse that enables the reset of the particular row indicated at any point in time by signal 430. The reset of the selected row is subject to the reset enable signal 440, which, as shown, enables reset for the first discarded image frame and for the rows 1 and 2 of the next frame (corresponding to FIGS. 6E and 6F) but then, as described above, suppresses the reset (i.e., is a low or binary zero signal) for rows 3 and 4 (corresponding to FIGS. 6G and 6H). A combined reset signal 710, corresponding to the logical conjunction of signal 420 and signal 440, is also shown in FIG. 7. As shown, combined reset signal 710 is a regularly repeating pulse that is absent at times 720, 730 corresponding to the reset-suppressions for rows 3 and 4.

The rows are read out via operation of the row readout signal 740, which is represented as a regularly repeating pulse controlling the read-out of the particular row indicated by address 700 (and which corresponds to, at the pixel level, e.g., the read operation described in reference to FIG. 5). The resulting total row-by-row integration times 750, correlated to the row numbers indicated in readout row address 700, are also provided in FIG. 7. The integration times 750 indicate that, as desired, upon read-out, rows 1 and 2 have an integration time of two cycles and rows 3 and 4 have an integration time of four cycles (their reset signal 420 having been suppressed via signal 440).

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. An image sensor comprising:
a pixel array comprising a plurality of rows of pixels for accumulating charge in response to incident light;
a row-driver circuit associated with each row of pixels;
electrically connected to the row-driver circuits, a control circuit configured to (i) for each row of pixels, reset the row of pixels by applying a row-reset signal to the row-driver circuit associated therewith and, thereafter, read out charge from the row of pixels, and (ii) for at least one selected row, suppress reset of at least one pixel thereof to allow charge to accumulate therein for a full-frame integration time prior to read-out, unselected rows having an integration time (a) less than the full-frame integration time and (b) corresponding to an elapsed time between application of the row-reset signal and read-out.

2. The image sensor of claim 1, wherein the control circuit comprises (i) a row-reset control line for carrying the row-reset signal and (ii) a reset-enable control line for carrying a reset-enable signal for enabling and suppressing reset.

3. The image sensor of claim 2, wherein each row-driver circuit comprises circuitry (i) having inputs connected to the row-reset control line and the reset-enable control line and (ii) for performing a logical conjunction of the row-reset signal and the reset-enable signal.

4. The image sensor of claim 3, wherein (i) the control circuit comprises a reset-row-address control line for carrying a reset-row-address signal for addressing a row to be reset, and (ii) the circuitry has an input connected to the reset-row-address control line.

5. The image sensor of claim 3, wherein the circuitry comprises one or more AND gates.

6. A method of image capture utilizing a pixel array comprising (i) a plurality of rows of pixels for accumulating charge in response to incident light and (ii) a row-driver circuit associated with each row of pixels, the method comprising:
exposing the pixel array to incident light;
for each row of pixels, resetting the row of pixels by applying a row-reset signal to the row-driver circuit associated therewith and, thereafter, reading out charge from the row of pixels; and
for at least one selected row, suppressing reset of at least one pixel thereof to allow charge to accumulate therein for a full-frame integration time prior to read-out, unselected rows having an integration time (a) less than the full-frame integration time and (b) corresponding to an elapsed time between application of the row-reset signal and read-out.

7. The method of claim 6, wherein suppressing reset of at least one pixel of a selected row of pixels comprises applying to the at least one pixel of the selected row a reset-enable signal having a polarity opposite a polarity of the row-reset signal applied to the selected row.
